(19) United States
(12) Patent Application Publication
(10) Pub. No.: US 2026/0009902 A1
(43) Pub. Date: Jan. 8, 2026

(54) DISTANCE MEASURING APPARATUS, PROCESSING APPARATUS, DISTANCE MEASURING METHOD, STORAGE MEDIUM

(71) Applicant: CANON KABUSHIKI KAISHA, Tokyo (JP)

(72) Inventors: HIROSHI NAKAOKA, Saitama (JP); YOHEI HORIKAWA, Tokyo (JP); TAKESHI OGAWA, Tokyo (JP); SHUNICHI WAKASHIMA, Tokyo (JP); TAKASHI HANASAKA, Tokyo (JP); KOSUKE NOBUOKA, Kanagawa (JP)

(21) Appl. No.: 19/326,477

(22) Filed: Sep. 11, 2025

Related U.S. Application Data
(63) Continuation of application No. PCT/JP2024/001419, filed on Jan. 19, 2024.

(30) Foreign Application Priority Data
Mar. 29, 2023 (JP) 2023-052560

(51) Int. Cl. G01S 17/10; G01S 7/484; G01S 7/4865; G01S 17/89; G01S 17/931

(52) U.S. Cl. CPC G01S 17/10; G01S 7/484; G01S 7/4865; G01S 17/89; G01S 17/931

(57) ABSTRACT

A distance measuring apparatus includes a light emitter configured to emit light onto an object and including a plurality of light emitting elements, and a drive unit configured to output a drive voltage for causing each light emitting element to emit the light, a light receiver configured to detect light reflected by the object among the light from the light emitter, measure a time of flight of the light from the light emitter, and generate distance data based on the time of flight, and one or more processors that operate to correct the distance data based on predetermined delay times.

### CROSS-REFERENCE TO RELATED APPLICATIONS

This application is a Continuation of International Patent Application No. PCT/JP2024/001419, filed on Jan. 19, 2024, which claims the benefit of Japanese Patent Application No. 2023-052560, filed on Mar. 29, 2023, each of which is hereby incorporated by reference herein in their entirety.

### BACKGROUND

### Field of the Technology

The aspect of the disclosure relates to one or more embodiments of a distance measuring technology of the time-of-flight (TOF) method.

### Description of the Related Art

In the TOF method, a distance to an object (object distance) is measured based on the time from when light is irradiated onto the object to when reflected light from the object is detected (time of flight of light). Japanese Patent Application Laid-Open No. 2019-060652 discloses a distance measuring apparatus that includes light emitting elements and light receiving elements arranged in a two-dimensional array, irradiates light onto an object through an imaging lens, and receives reflected light from the object to obtain three-dimensional distance information.

The TOF method that measures the round-trip time of light cannot accurately acquire an object distance due to a variety of delays such as the delay between the time when an instruction to emit light is issued to the light emitting element and the time when the light emitting element actually emits light, or the delay between the time when an instruction to emit light is issued and the time when measurement of the time of flight through the light receiving element starts.

### SUMMARY

One or more embodiments of a distance measuring apparatus according to one or more aspects of the disclosure may include a light emitter configured to emit light to be irradiated onto an object and including a light emitting element, and a drive unit configured to output a drive voltage for causing the light emitting element to emit the light, a light receiver configured to detect light reflected by the object among the light from the light emitter, measure a time of flight of the light from the light emitter, and generate distance data based on the time of flight, one or more memories storing instructions, and one or more processors that, upon execution of the instructions, operate to correct the distance data based on a first delay time from when the light emitter is instructed to emit the light to when the light emitter emits the light, a second delay time from when the light emitter is instructed to emit the light to when the light receiver starts measuring the time of flight, and a third delay time from when the drive unit outputs the drive voltage to when the light emitting element emits the light. The light emitter includes a plurality of light emitting elements. The one or more processors operate to perform correction based on the third delay time for each light emitting element.

One or more embodiments of a distance measuring apparatus according to one or more aspects of the disclosure may include a light emitter configured to emit light to be irradiated onto an object, a light receiver configured to detect light reflected by the object among the light from the light emitter, measure a time of flight of the light from the light emitter, and generate distance data based on the time of flight, one or more memories storing instructions, and one or more processors that, upon execution of the instructions, operate to correct the distance data based on a first delay time from when the light emitter is instructed to emit the light to when the light emitter emits light, and a second delay time from when the light emitter is instructed to emit the light to when the light receiver starts measuring the time of flight, correct the distance data based on a third delay time from when a drive unit in the light receiver outputs a drive voltage for causing the light emitting element to emit the light to when the light emitting element emits the light, correct the distance data based on a fourth delay time from when the signal is output from the light receiving element to when the signal output from the light receiving element reaches the measuring unit, correct the distance data according to an image height in the light receiver and a focal length of an imaging optical system through which the light emitted from the light emitter and the light reflected by the object pass, and correct the distance data based on a fifth delay time according to a temperature in at least one of the light emitter and the light receiver.

One or more processing apparatuses may include one or more distance measuring apparatuses in accordance with one or more other aspects of the disclosure. One or more distance measuring methods corresponding to the above one or more distance measuring apparatuses also constitute another aspect of the disclosure. A storage medium storing a program that causes a computer to execute the above one or more distance measuring methods also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configuration of a distance measuring apparatus according to a first embodiment.

FIG. 2 illustrates the configuration of a light emitter according to the first embodiment.

FIG. 3 illustrates the configuration of a light receiver according to the first embodiment.

FIG. 4 illustrates the pixel configuration on the light receiver according to the first embodiment.

FIGS. 5A, 5B, and 5C illustrate the configuration of an optical system according to the first embodiment.

FIG. 6 is a flowchart illustrating processing according to the first embodiment.

FIG. 7 is a timing chart illustrating the operation of a TDC array unit according to the first embodiment.

FIG. 8 illustrates an optical path length difference according to the first embodiment.

FIG. 9 illustrates a histogram according to the first embodiment.

FIG. 10 is a block diagram illustrating the configuration of a distance measuring apparatus according to a second embodiment.

FIG. 11 is a flowchart illustrating processing according to the second embodiment.

FIG. 12 is a block diagram illustrating the configuration of a distance measuring apparatus according to a third embodiment.

FIG. 13 is a block diagram illustrating the configuration for temperature correction of a light receiver according to the third embodiment.

FIG. 14 is a graph illustrating a fluctuation component of a delay amount in the third embodiment.

FIG. 15 illustrates coefficients for expressing correction values in the third embodiment by an approximation equation.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

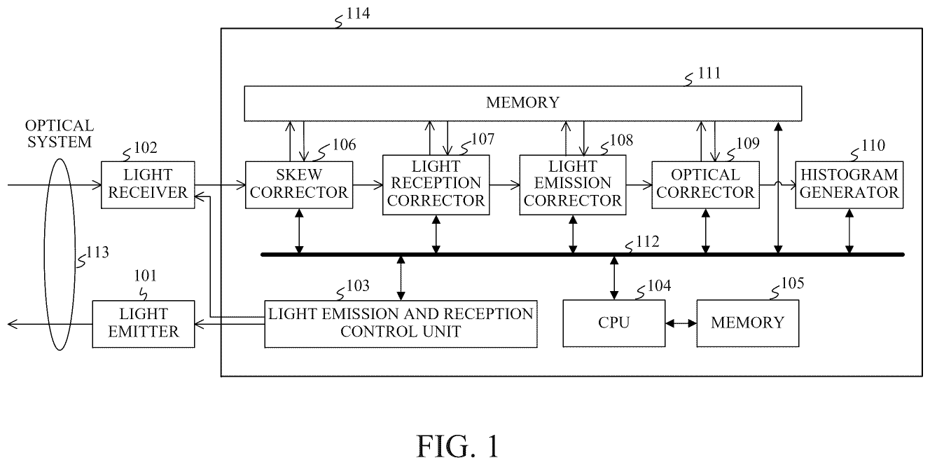

FIG. 1 illustrates the configuration of a distance measuring apparatus according to a first embodiment. The distance measuring apparatuses according to this embodiment and other embodiments described later perform TOF distance measurement in the Light Detection and Ranging (LiDAR) technology.

### Overall Configuration

The distance measuring apparatus includes a light emitter 101, a light receiver 102, an optical system 113, and a signal processing circuit 114. The light emitter 101 causes a plurality of light emitting elements arranged in a two-dimensional array to emit light based on a light emission command output from a light emission and reception control unit 103 in the signal processing circuit 114.

The light emission command is also output to the light receiver 102.

The light emitted from the light emitter 101 is irradiated onto an unillustrated object or target via the optical system 113. The optical system 113 has a half-mirror function that transmits part of the incident light and reflects the rest, and a reflection suppression function.

The light emitted by the light emitter 101 and reflected by the object is received by the light receiver 102 via the optical system 113. The light receiver 102 generates distance data from a time period from emission of the light emitter 101 to reception of the reflected light by the light receiver 102 (time of flight of light TOF) based on the light emission instruction (or light reception instruction output simultaneously) output from the light emission and reception control unit 103. The signal processing circuit 114 has the above light emission and reception control unit 103, and performs signal processing (correction, etc.) described below for the distance data output from the light receiver 102.

### Configuration of Signal Processing Circuit

The signal processing circuit 114 includes the light emission and reception control unit 103, a CPU (one or more processors) 104, a memory 105, a skew corrector (one or more processors) 106, a light reception corrector (one or more processors) 107, a light emission corrector (one or more processors) 108, an optical corrector (one or more processors) 109, a histogram generator (one or more processors) 110, and a memory (one or more memories) 111. The skew corrector 106 corresponds to a first corrector, the light reception corrector 107 corresponds to a third corrector, the light emission corrector 108 corresponds to a second corrector, and the optical corrector 109 corresponds to a fourth corrector.

The light emission and reception control unit 103 outputs control signals to the light emitter 101 and the light receiver 102 at predetermined timings. The CPU 104 as a computer controls the light emission and reception control unit 103, the skew corrector 106, the light reception corrector 107, the light emission corrector 108, the optical corrector 109, and the histogram generator 110 via a bus 112. The CPU 104 operates according to a program stored in the memory 105 and executes the processing described below.

The skew corrector 106 performs skew correction as a first correction on the distance data output from the light receiver 102 using skew correction data stored in the memory 111. The light reception corrector 107 performs a second light reception correction on the distance data after the skew correction in the skew corrector 106 using the light reception correction data stored in the memory 111. The light emission corrector 108 performs a third light emission correction on the distance data after the light reception correction in the light reception corrector 107 using the light emission correction data stored in the memory 111. The optical corrector 109 performs a fourth optical correction on the distance data after the light emission correction in the light emission corrector 108 using the optical correction data stored in the memory 111. The histogram generator 110 creates a histogram of the distance data after the optical correction in the optical corrector 109 or after the light emission correction in the light emission corrector 108, removes noise components, and averages the distance measurement result. Distance L to the object can be obtained by substituting time of flight TOF obtained in this way into the following equation (1):

$$L = TOF \times c / 2 \qquad ( 1 )$$

where c is the light speed.

### Light Emitter

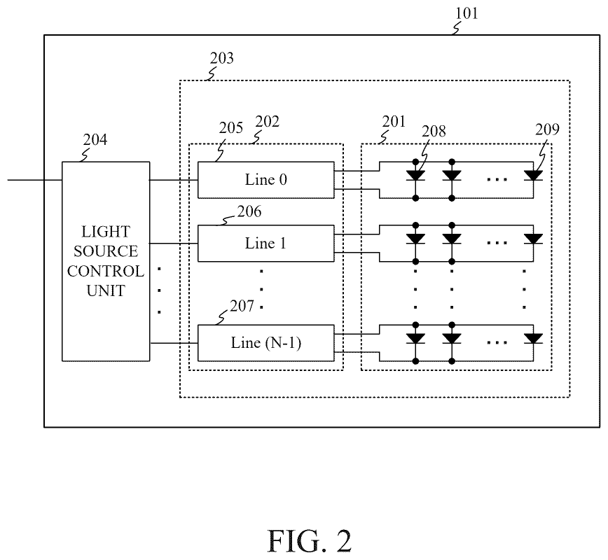

FIG. 2 illustrates an example of the configuration of the light emitter 101. The light emitter 101 includes a light source unit 203 and a light source control unit 204.

The light source unit 203 includes a light emitting element array 201 and a light emitting element drive circuit 202 as a drive unit. The light emitting element array 201 is a two-dimensional array of Vertical Cavity Surface Emitting LASERs (VCSELs) that are light emitting elements 208 and 209 arranged on a substrate. The light emitting element drive circuit 202 is a one-dimensional array of light emitting element line drive circuits 205, 206, and 207.

The light emitting elements may be other than VCSELs, but they may be integrated into a one-dimensional or two-dimensional array. Examples include edge-emitting lasers and light emitting diodes (LEDs). In the case where an edge-emitting laser is used as the light emitting element instead of a VCSEL, a laser bar stack arranged one-dimensionally on a substrate or a laser bar stack arranged two-dimensionally on a substrate to form a light emitting element array can be used as the light emitting element array. In the case where an LED is used as the light emitting element, a two-dimensional array of LEDs can be used.

The wavelength of the light emitted by the light emitting element in the distance measuring apparatus according to this embodiment may be in the near-infrared band to suppress the influence of ambient light. However, light in a band other than the near-infrared band may be used. The VCSEL is produced by a semiconductor process using materials used in conventional edge-emitting lasers and surface-emitting lasers, and GaAs-based semiconductor materials can be used as the main material when the VCSEL is configured to emit light in the near-infrared band. In this case, the dielectric multilayer film forming the Distributed Bragg Reflector (DBR) reflector constituting the VCSEL can include two thin films made of materials with different refractive indices alternately and periodically laminated (GaAs/AlGaAs). The wavelength of the emitted light can be changed by adjusting the element combination and composition of the compound semiconductor.

The VCSELs that make up the VCSEL array have electrodes for injecting current and holes into the active layer, and the electrodes are shared in the line direction and connected to the light emitting element line drive circuits 205, 206, and 207 arranged in each line. By operating only a specific light emitting element line drive circuit among the light emitting element drive circuits 202, current is injected (voltage is applied) only to the VCSELs belonging to a specific line, and it is possible to make the light emitting elements in the specific line emit light.

### Light Receiver

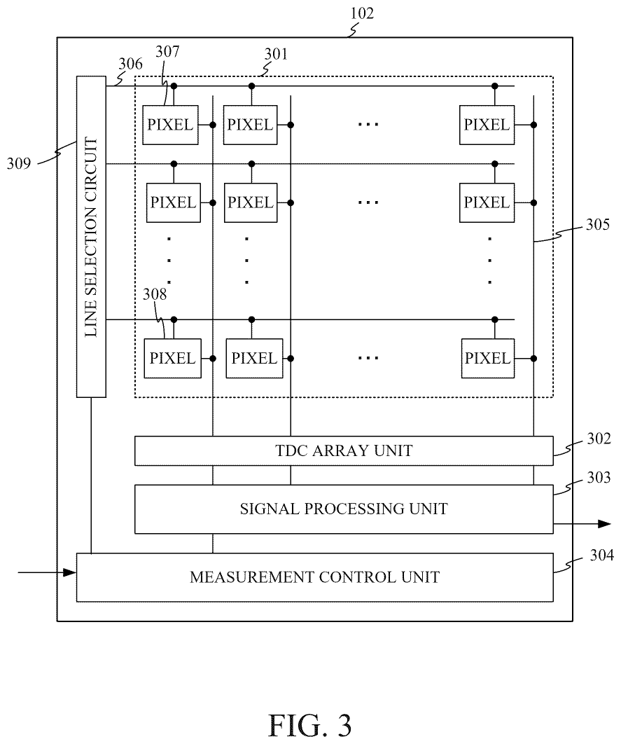

FIG. 3 illustrates an example of the configuration of the light receiver 102. The light receiver 102 includes a light receiving element array 301 consisting of multiple pixels 307 and 308 arranged in a two-dimensional array, a Time-to-Digital Converter (TDC) array unit 302, a signal processing unit 303, and a measurement control unit 304. The light receiver 102 further includes a line selection circuit 309 for enabling only a specific line, line selection pulse wiring 306 for outputting an output signal of the line selection circuit 309 to pixels 307 and 308, and a pixel output line 305 for outputting a pixel output signal to the TDC array unit 302.

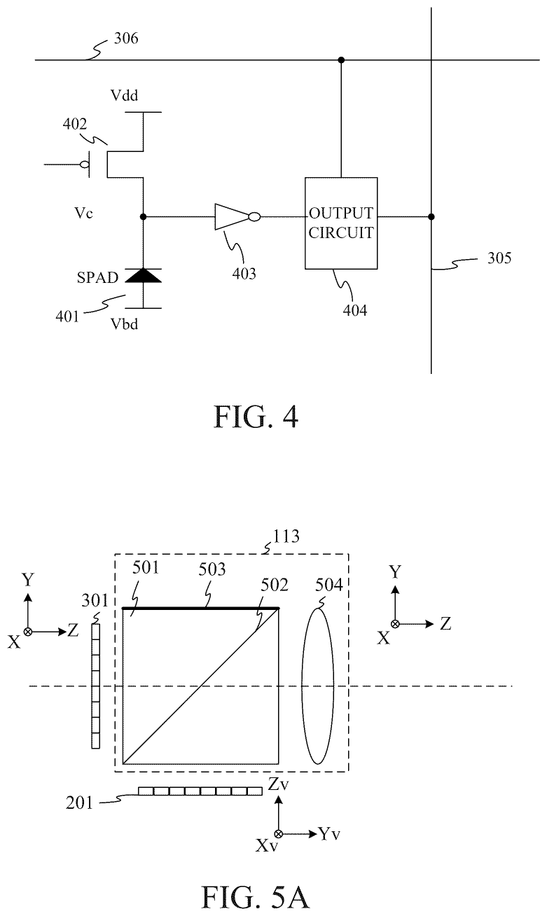

FIG. 4 illustrates an example of the configuration of each pixel. Each pixel includes a Single Photon Avalanche Diode (SPAD) element 401, which is a light receiving element, a load transistor 402, an inverter 403, a pixel output circuit 404, line selection pulse wiring 306, and a pixel output line 305.

The SPAD element 401 includes a light receiving region and an avalanche region. Light incident on the SPAD element 401 is photoelectrically converted in the light receiving region, and electrons and holes are generated. The positively charged holes are discharged via the anode electrode Vbd. Negatively charged electrons are transported as signal charges to the avalanche region by an electric field set so that the potential in the light receiving region is lowered toward the avalanche region. The signal charges that reach the avalanche region undergo avalanche breakdown due to the strong electric field in the avalanche region, which generates an avalanche current.

When no avalanche current flows, the voltage of the anode electrode Vbd is set so that a reverse bias equal to or greater than the breakdown voltage is applied to the avalanche region. At this time, no current flows through the load transistor 402, so the cathode potential Vc is close to the power supply voltage Vdd, and the output signal of the inverter 403 is “0.”

When an avalanche current is generated by the arrival of a photon, the voltage of Vc drops and the output of the inverter 403 is inverted. In other words, the inverter output changes from “0” to “1.” In a case where the potential of Vc drops, the reverse bias associated with the SPAD element 401 decreases, and the generation of the avalanche current stops when the reverse bias falls below the breakdown voltage.

Thereafter, a hole current flows from Vdd to Vc via the load transistor 402, the cathode potential Vc rises, and the inverter output returns from “1” to “0,” returning to the state before the arrival of the photon.

In a pixel where the line selection pulse wiring 306 is turned on, the output of the inverter 403 is controlled to be output to the pixel output line 305, and in a pixel where the line selection pulse wiring 306 is turned off, the inverter output is controlled to be disconnected from the pixel output line 305. Thus, it is possible to detect only the light that is incident on the pixels belonging to a specific line selected by the line selection circuit 309.

Thus, the light output signal (detection signal) of the pixel belonging to the line selected by the line selection circuit 309 is output as a digital signal to the TDC array unit 302. In the TDC array unit 302, a counter generation circuit (not illustrated) counts up in synchronization with a clock signal of a predetermined frequency from the emission start time of the light emitting element in the light emitter 101, and the count stops at the light reception start time when the light is detected by the light receiver 102. Hence, the TDC array unit 302 calculates the time of flight TOF as the counter value TOFcnt. Where F is a frequency of the counter, and the distance L to the object (target) is calculated from equation (1) using the following equation (2):

$$L = TOFcnt \times 1 / F \times c / 2 \qquad ( 2 )$$

### Optical System

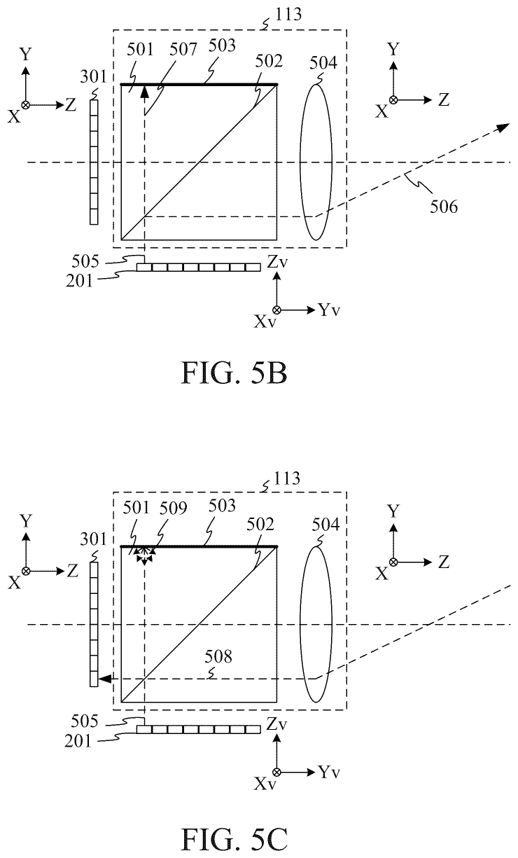

FIGS. 5A to 5C illustrate the configuration (cross section) of the optical system 113. The optical system 113 includes a beam splitter 501 and an imaging lens 504. FIGS. 5A to 5C also illustrate cross sections of the light emitting element array 201 and the light receiving element array 301.

The light emitting element array 201 and the light receiving element array 301 are in a conjugate relationship via the half-mirror 502 of the beam splitter 501, and each light emitting element and light receiving element are also in a conjugate relationship. While FIG. 5A schematically illustrates each of the light emitting element array 201 and the light receiving element array 301 as eight lines, the number of lines is not limited to this example. While the light emitting elements and the light receiving elements are illustrated to have a one-to-one conjugate relationship, the number of light receiving elements may be n×n times the number of light emitting elements, and one light emitting element may be arranged to have a conjugate relationship with n×n light receiving elements.

The line numbers of the light emitting element lines are assigned in ascending order from the smaller Yv side to the larger Y side in FIG. 5A. The line numbers of the light receiving element lines are assigned in ascending order from the smaller Y side to the larger Y side in the same figure. The light emitting element lines and light receiving element lines with the same line number are in a conjugate relationship.

FIG. 5B illustrates the optical path of light 505 emitted from a light emitting element of line number 0 in the light emitting element array 201. Light 505 emitted from the light emitting element is split into light 506 that is reflected by the half-mirror 502 and irradiated onto the object, and light 507 that transmits through the half-mirror 502 and travels toward the reflection suppression structure 503.

FIG. 5C illustrates light 508 reflected from the object and light 509 reflected from the reflection suppression structure 503. The reflected light 508 enters a light receiving element that is in a conjugate relationship with the light emitting element that emitted light.

The surface of the reflection suppression structure 503 is structured to cause at least one of transmission and absorption so as to reduce the reflectance of the wavelength of light emitted from the light emitting element. Such a surface structure may be a structure in which dielectrics with different refractive indices are stacked, or may be a structure finer than the wavelength. Diffusive reflection by the reflection suppression structure 503 prevents the light reflected by the beam splitter 501 from entering a light receiving element that is in a conjugate relationship with the light emitting element that emitted light. Thereby, erroneous distance measurement can be suppressed.

Instead of the reflection suppression structure 503, a rectangular structure with a period twice the spacing of the light emitting elements in the line direction may be used, and the light reflected by the beam splitter 501 may enter the light receiving elements of a line that is not in a conjugate relationship with the light emitting element that emitted light, so as to suppress erroneous distance measurement. This embodiment outputs to the TDC the output from the pixels of the light receiving element line that is in a conjugate relationship with the light emitting element line that has emitted light. The TDC detects the time from the emission timing to the light reception timing at which light enters the light receiving element line that is in a conjugate relationship with the light emitting element line that emitted light, and does not react to light incident on other light receiving element lines. Although the first line has been described so far, this is similarly applicable to the other lines.

### Processing

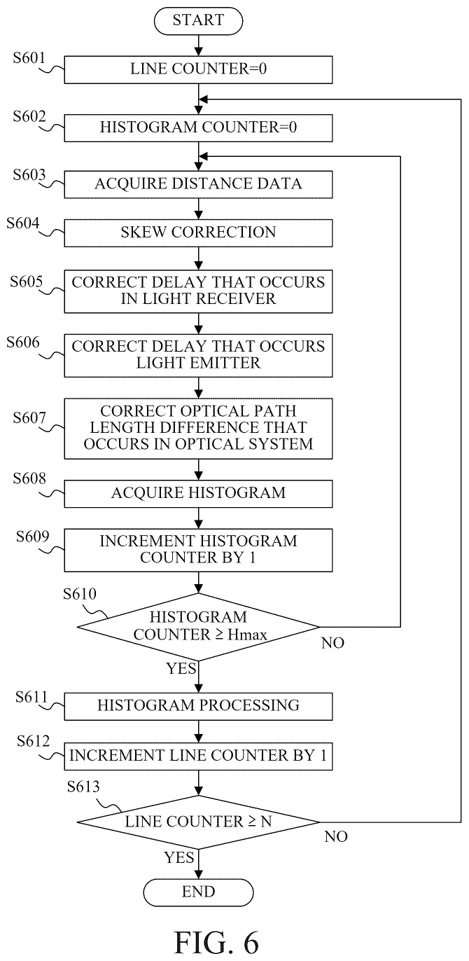

A flowchart in FIG. 6 illustrates processing (distance measurement method) to be executed by the CPU 104 according to this embodiment. “S” in FIG. 6 stands for the step.

In step 601, the CPU 104 sets a line counter that determines the line that emits and receives light to 0.

Next, in step 602, the CPU 104 sets a histogram counter, which determines the number of measurements to obtain a histogram, to 0.

Next, in step 603, the CPU 104 acquires distance data from the light receiver 102. Here, the CPU 104 causes the line selection circuit 309 to select a line corresponding to the line counter through the light emission and reception control unit 103, and sets it so that detection signals from the pixels in the corresponding line are output to the TDC array unit 302 through the pixel output line 305. Then, the light emitting element line drive circuit of the line corresponding to the line counter is operated, and a drive voltage is applied to the light emitting element belonging to the corresponding line, causing the light emitting element to emit a short pulse. The light reflected by the object and returned enters a light receiving element that is conjugate with the light emitting element that has emitted the light. When the detection signal becomes “1” due to light reception, the CPU 104 causes the TDC to measure the time from light emission (FOT) through the light emission and reception control unit 103.

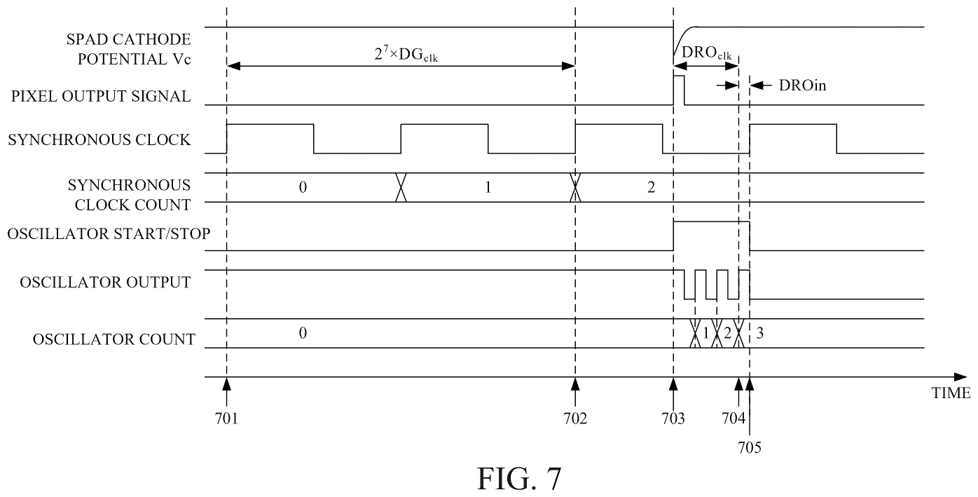

FIG. 7 illustrates the operation of the light receiver 102 from the time when a light emitting element belonging to a specific line of the light emitting element array 201 emits light to when the SPAD element 401, which is the light receiving element at the corresponding line, receives the reflected light and the TDC count ends. From the top, FIG. 7 illustrates changes in the SPAD cathode potential Vc, pixel output signal (detection signal), synchronous clock, synchronous clock count, oscillator start/stop signal, oscillator output, and oscillator count. The SPAD cathode potential Vc is an analog voltage, with the upper side in the figure indicating a high voltage. The synchronous clock, oscillator start/stop signal, and oscillator output are digital signals, with the upper side in the figure indicating an on state and the lower side indicating an off state. The synchronous clock count and oscillator count are digital values, and are illustrated as decimal numbers.

In the light emitter 101, at leading-edge time 701 (second time) of the synchronous clock supplied from the light emission and reception control unit 103, the corresponding light emitting element line drive circuit is driven so that a light emitting element belonging to a specific line of the light emitting element array 201 emits light. The TDC array unit 302 of the light receiver 102 starts counting the leading edge of the synchronous clock from the leading-edge time 701 when the light emitting element emits light. Time 702 is the last leading edge of the synchronous clock before the light reflected from the object is detected by the light receiver 102 at time 703, which will be described next.

At time 703, the light reflected from the object is received by the pixel, causing the SPAD cathode potential Vc to drop, and the pixel output signal changes from “0” to “1.” When the pixel output signal becomes “1,” the oscillator start/stop signal changes from “0” to “1.” When the oscillation switch provided in the TDC array unit 302 is turned on, oscillation starts, and a leading edge appears in the oscillator output every time the signal makes two revolutions in the oscillator, and the oscillator count is performed. At time 703, counting the leading edge of the synchronous clock stops, and the count value DG_{clk} at that time (2 in FIG. 7) is held.

Time 705 is the time when the synchronous clock rises for the first time after the oscillator starts. In response to this leading edge of the synchronous clock, the oscillator start/stop signal becomes “0,” the oscillation switch turns off, and the oscillator count value DRO_{clk} (3 in FIG. 7) is held as it is.

In this embodiment, the number of oscillator buffer stages is eight, and the resolution ratio of the delay time tbuff for one step to the synchronous clock is 1/128. Thereby, an oscillator count that can be counted with a resolution of 1/16 of the synchronous clock, and an oscillator internal signal that can be counted with a resolution of 1/128 of the synchronous clock.

Thus, the synchronous clock count value DG_{clk} is a value obtained by counting the time from time 701 to time 702 with a time resolution of 2⁷×tbuff. The oscillator count value DRO_{clk} is a value obtained by counting the time from time 703 to time 704 with a time resolution of 2⁴×tbuff. The oscillator internal signal count value DROᵢₙ is the value obtained by counting the time from time 704 to time 705 with a time resolution of tbuff. One TDC operation is completed by outputting DRO, which is a result of performing the processing illustrated in the following equation (3) for the oscillator count value DRO_{clk} and the oscillator internal signal count value DROᵢₙ, to the signal processing unit 303. DRO is the value obtained by counting the time from time 703 to time 705 with tbuff.

$$DRO = {2}^{4} \times {DRO}_{clk} + {DRO}_{in} \qquad ( 3 )$$

The time from time 702 to time 705 is equal to one period of the synchronous clock, 2⁷×tbuff. Therefore, as illustrated in the following equation (4), by subtracting DRO from the count value corresponding to one cycle of the synchronous clock and adding this to DG_{clk}, the value DTOF, which is the time of flight of light from time 701 to time 703, counted by tbuff is calculated:

$$DTOF = {2}^{7} \times {DG}_{clk} + ( {2}^{7} - DRO ) = {2}^{7} \times {DG}_{clk} + ( {2}^{7} - {2}^{4} \times {DRO}_{clk} - {DRO}_{in} ) \qquad ( 4 )$$

DTOF obtained in this way by the TDC array unit 302 becomes distance data. The obtained distance data is shaped into an output format by the signal processing unit 303 and output to the signal processing circuit 114.

Next, in step 604, the CPU 104 causes the skew corrector 106 to perform skew correction for the distance data DTOF obtained in step 603. In FIG. 7, it is necessary to cause the light emitting elements belonging to a specific line of the light emitting element array 201 to emit light at time 701, and to start counting by the TDC array unit 302 at the same time. However, since the light emitter 101 and the light receiver 102 are mounted as different devices on a board (not illustrated), there is a possibility that the time (second time) at which the light emission instruction reaches the light emitter 101 and the time (third time) at which the light emission instruction reaches the light receiver 10 as a count start instruction may be relatively different from the time (first time) at which the light emission instruction is issued from the light emission and reception control unit 103.

In this embodiment, Tvd is a first delay time from the first time at which the light emission instruction is issued from the light emission and reception control unit 103 to the time at which the light emission instruction reaches the light source control unit 204 in the light emitter 101, i.e., the second time at which the light emitting element array 201 starts emitting light. Tsd is a second delay time from the first time to the time when the light emission command reaches the measurement control unit 304 in the light receiver 102, i.e., the third time when the light receiver 102 starts measuring the time of flight (counting the leading edge of the synchronous clock in the TDC array unit 302). Then, where F is a frequency of the counter that counts at a predetermined period tbuff, the delay times Tvd and Tsd are converted into distance data Dvd and Dsd by equations (5) and (6), respectively:

$$Dvd = F \times Tvd \qquad ( 5 )$$

$$Dsd = F \times Tsd \qquad ( 6 )$$

Therefore, distance data DTOF′ after skew correction that considers the above delay times for the distance data DTOF obtained by the TDC array unit 302 is expressed by the following equation (7):

$${DTOF}^{′} = DTOF + ( Dsd - Dvd ) \qquad ( 7 )$$

The delay times Tvd and Tsd may be calculated in advance by simulation calculation using parameters such as the wiring length and impedance on the board. The delay times Tvd and Tsd may be calculated by converting the distance data DTOF obtained by actual measurement using an object with a known distance into a spatial distance and extracting a difference between this and the actual distance. The delay times Tvd and Tsd can be provided as skew correction data to the skew corrector 106 by storing the delay times Tvd and Tsd in the memory 105, in the memory 111 from the CPU 104 via the bus 112.

In a case where the light emitter 101 has a plurality of light source control units 204, the delay time may differ for each light emitting element controlled by each light source control unit 204. Thus, errors in the distance data due to delays in the light emission instruction and light reception instruction can be reduced by acquiring the delay time of the first light source control unit for each light source control unit 204, such as Tvd1 for the delay time of the first light source control unit, Tvd2 for the delay time of the second light source control unit, . . . , and correcting distance data for each light source control unit 204.

In step 604, skew correction was performed for the distance data DTOF using distance data Dvd and Dsd converted from delay times Tvd and Tsd. On the other hand, the delay times Tvd and Tsd may be converted to count values at tbuff, and skew correction may be performed for the count values as DTOF using the converted count values.

Next, in step 605, the CPU 104 causes the light reception corrector 107 to perform light reception correction for the skew-corrected distance data DTOF′ to correct delays that occur within the light receiver 102.

The delays that occur within the light receiver 102 will be described with reference to FIG. 3. The light receiving element array 301 is configured in a matrix to acquire distance data to the object in a two-dimensional area. The TDC array unit 302 as a measuring unit is provided at the end of the pixel output line 305 to receive the output from the pixels in each column of the light receiving element array 301 as input. At this time, in a case where the distances to the corresponding objects are equal for the pixels 307 and 308, which are positioned differently in FIG. 3, the light emission time of the light emitting element array 201 in the light emitter 101 to the time when the SPAD cathode potential Vc drops is the same. However, the wiring length from the pixel 307 to the TDC array unit 302 and the wiring length from the pixel 308 to the TDC array unit 302 are different from each other. Thus, there is a time difference between the time (fourth time) when an output signal is output from the pixels 307 and 308 that detect the reflected light and the time (fifth time) when the output signal reaches the TDC array unit 302 and measurement of the time of flight starts. This time difference appears as a count value difference of a counter provided in the TDC array unit 302, i.e., a difference in the acquired distance data.

Thus, the light reception corrector 107 corrects the distance data corrected by the skew corrector 106 for each pixel of the light receiver 102. In this embodiment, pixels are selected by line in the line selection circuit 309 of the light receiver 102, and output signals from these pixels belonging to the same line reach the TDC array unit 302 at the same time. Thus, correction for each line can reduce errors. Where n (n=0, 1, 2, . . . , N−1) is the line number and Ts(n) the delay amount as the fourth delay time of the pixel belonging to the selected line, the delay amount Ts(n) is converted into distance data (delay distance) illustrated in the following equation (8):

$$Ds ( n ) = F \times Ts ( n ) \qquad ( 8 )$$

DTOF′(n) is distance data corrected by the skew corrector 106 using the line number n. Then, the corrected distance data DTOF″(n) considering the delay distance Ds(n) generated in the light receiver 102 is expressed by the following equation (9):

$${DTOF}^{″} ( n ) = {DTOF}^{′} ( n ) - Ds ( n ) \qquad ( 9 )$$

The delay amount Ts(n) may be obtained in advance by simulation calculation using parameters such as the wiring length and impedance on the light receiver 102. Alternatively, the skew-corrected distance data DTOF′ obtained by actual measurement using an object with a known distance may be converted into a spatial distance, and the delay amount Ts(n) may be calculated by extracting the difference between this and the actual distance. The delay amount Ts(n) can be provided to the light reception corrector 107 as light reception correction data by storing the delay amount Ts(n) in the memory 105, in the memory 111 via the bus 112 from the CPU 104.

Storing the delay amounts Ts(n) for all N lines in the memory 111 may result in an excessively large storage capacity. In this case, the storage capacity in the memory 111 can be reduced by storing only Ts(0) and Ts(N−1) in the memory 111 and generating the delay amount Ts(n) in the light reception corrector 107 by linear interpolation as illustrated in the following equation (10):

$$Ts ( n ) = Ts ( 0 ) + n \{ Ts ( 0 ) - Ts ( N - 1 ) \} / ( N - 1 ) \qquad ( 10 )$$

The effect of reducing the storage capacity of the memory 111 can be obtained for any delay amount less than N, not limited to the two data, Ts(0) and Ts(N−1). In a case where the delay amount cannot be linearly approximated, it can be approximated by a more complex polynomial and the memory 111 can store the coefficients of the polynomial, and the storage capacity of the memory 111 can be reduced.

Next, in step 606, the CPU 104 causes the light emission corrector 108 to perform light emission correction for the distance data DTOF″(n) after light reception correction in order to correct the delay that occurs within the light emitter 101. This embodiment performs light emission correction after light reception correction. For example, in a case where light from a pixel in the first line of the light emitter 101 enters a pixel in the second line of the light receiver 102, the obtained distance data and the coordinate relationship of each pixel differ between the light receiver 102 and the light emitter 101. In such a case, it is the light receiver 102 that has the delay amount superimposed last. Thus, it is possible to perform a more accurate correction by first correcting the delay amount of the light receiver 102, then performing coordinate conversion to return to the coordinate system of the light emitter 101, and then correcting the delay amount of the light emitter 101. However, light reception correction may be performed after light emission correction by performing coordinate conversion on the correction value that corrects the delay of the light emitter 101.

Referring now to FIG. 2, The delay occurring in the emitter 101 will be described. The light emitting element array 201 is configured in a matrix in order to obtain distance data to the object in a two-dimensional area. On the other hand, in the light emitting element drive circuit 202, the light emitting element line drive circuits 205, 206, and 207 are arranged one-dimensionally for each line. At this time, the wiring lengths to the light emitting elements 208 and 209 connected to the light emitting element line drive circuit 205 are different from each other. Therefore, a time difference occurs between the time (sixth time) when the drive voltage is output from the light emitting element line drive circuit 205 to the time (seventh time) when the light emitting elements 208 and 209 actually emit light. The light receiver 102 counts the pixels connected to the corresponding lines as described above on the premise that the light emission timings of the light emitting elements 208 and 209 are the same, so an error occurs in the obtained distance data.

Thus, the light emission corrector 108 performs correction for each light emitting element of the light emitter 101 for the distance data corrected by the light reception corrector 107. In this embodiment, in the light emitting element drive circuit 202 of the emitter 101, light emitting elements are selected by column, so that light emitting elements belonging to the same column emit light at the same time. Therefore, if correction is performed for each column, errors can be reduced. Where m (m=0, 1, 2, . . . , M−1) is the column number and Tv(m) is a delay amount as the third delay time for the light emitting element belonging to the selected column, the delay amount Tv(m) is converted to distance data illustrated in the following equation (11):

$$Dv ( m ) = F \times Tv ( m ) \qquad ( 11 )$$

DTOF″(m) is distance data after light reception correction by the light reception corrector 107 using the column number m. At this time, the corrected distance data DTOF′″(m) considering the delay distance Dv(m) generated by the light emitter 101 is expressed by the following equation (12):

$${DTOF}^{′′′} ( m ) = {DTOF}^{″} ( m ) - Dv ( m ) \qquad ( 12 )$$

The delay amount Tv(m) may be calculated in advance by a simulation calculation using parameters such as the wiring length and impedance on the light emitter 101. Alternatively, the distance data DTOF″ obtained by actual measurement using an object with a known distance may be converted into a spatial distance, and the delay amount Tv(m) may be calculated by extracting a difference between this and the actual distance. The delay amount Tv(m) can be provided as emission correction data to the emission corrector 108 by storing the delay amount Tv(m) stored in the memory 105, in the memory 111 via the bus 112 from the CPU 104.

The storage capacity may become too large if the delay amount Tv(m) for all M columns is stored in the memory 111. In this case, only two data, Tv(0) and Tv(M−1), are stored in the memory 111, and the emission corrector 108 may generate the delay amount Tv(m) using linear interpolation illustrated in the following equation (13) to reduce the storage capacity in the memory 111:

$$Tv ( m ) = Tv ( 0 ) + m \{ Tv ( 0 ) - Tv ( M - 1 ) \} / ( M - 1 ) \qquad ( 13 )$$

The effect of reducing the storage capacity of memory 111 can be obtained for any delay amount less than M, not limited to the two data, Tv(0) and Tv(M−1). In a case where the delay amount cannot be linearly approximated, the storage capacity of memory 111 can be reduced by approximating it with a more complicated polynomial and storing the coefficients of the polynomial in the memory 111.

In a case where there is misalignment between the light emitting element array 201 of the emitter 101 and the light receiving element array 301 of the light receiver 102 on an element-by-element basis, the correction data to be used may be adjusted to match the misalignment amount for proper correction. For example, in a case where the pixel pitch of the light receiving element array 301 differs from the pitch of the received light, the acquired distance data is generated based on the arrangement of the light receiving element array 301. Thus, the light reception corrector 107 first corrects the delay occurring in the light receiver 102 for the distance data after skew correction, and performs geometric transformation processing for the pitch misalignment for the corrected distance data. Thereafter, the light emission corrector 108 corrects the delay occurring in the light emitter 101. Thereby, distance data can be acquired with higher accuracy.

Next, in step 607, the CPU 104 causes the optical corrector 109 to perform optical correction for the distance data DTOF″(m) after light emission correction as a correction for the optical path length difference occurring in the optical system 113.

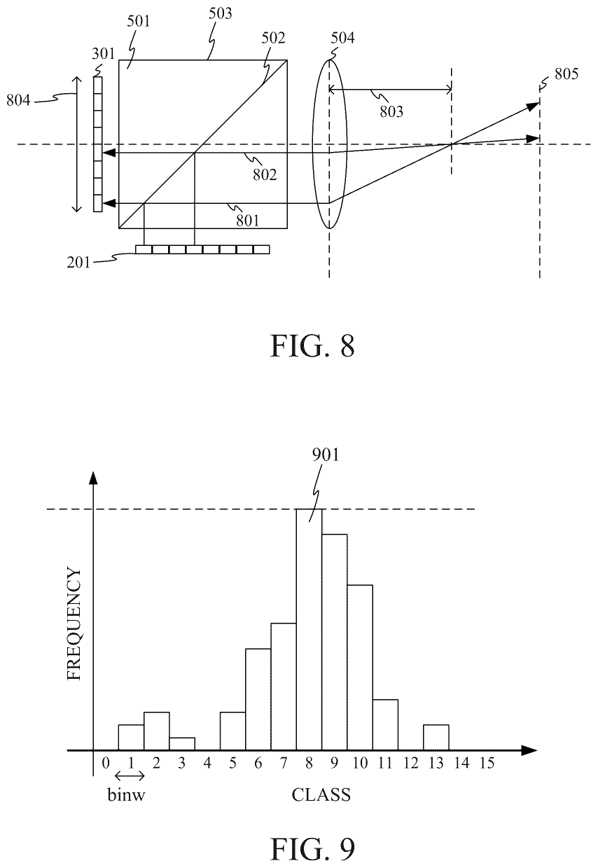

FIG. 8 illustrates a schematic diagram of optical paths when light is irradiated onto an object 805 located at the same distance. An optical path 801 illustrates an optical path of light emitted from a light emitting element at line number 0 of the light emitting element array 201. An optical path 802 illustrates an optical path of light emitted from a light emitting element at line number 3 of the light emitting element array 201. The laser light emitted as parallel light from these light emitting elements is irradiated onto the object at a predetermined angle relative to the optical axis via an image-side telecentric imaging lens 504 as the optical system 113. The light following the optical path 801 and the light following the optical path 802 have different optical path lengths, that is, flight distances, from when the light is emitted from the light emitting element to when it reaches the object 805, is reflected there, and reaches the light receiving element of the light receiving element array 301. The flight distance difference results in a TOF difference. Therefore, a difference occurs in the distance data calculated from the TOF of the light following optical path 801 and the TOF of the light following optical path 802. The angle of view φ of the imaging lens 504 is expressed by the following equation (14):

$$φ = 2 \times arctan ( d / 2 f ) \qquad ( 14 )$$

where f is a focal length 803 of the imaging lens 504, and d is a diagonal length 804 of the light receiver 102.

In a case where the angle of view φ is replaced with a distance (image height) r from the optical center of the light emitting element, an angle θ(r) from the optical axis of the light path for each light emitting element is expressed by the following equation (15):

$$θ ( r ) = 2 \times arctan ( r / 2 f ) \qquad ( 15 )$$

Distance L(r) to an object after optical correction can be calculated by the following equation (16):

$$L ( r ) = \{ {DTOF}^{′′′} ( r ) - 2 \times Dofst \} / 2 \times cos \{ arctan ( r / 2 f ) \} + Dofst \qquad ( 16 )$$

where DTOF′″(r) is distance data obtained from an output signal of the pixel corresponding to the image height r in the light receiving element array 301, and Dofst is a distance on the optical axis from the light receiving element array 301 to the imaging lens 504.

The distance L(r) to the object obtained in this way has a high affinity for focus control in acquiring a two-dimensional plane image signal captured by a camera using an imaging optical system similarly to the distance measuring apparatus. On the other hand, in a case where the distance L(r) is used to obtain three-dimensional position information (distance map), optical correction may not be performed for the obtained distance data because distance data based on the focus of the imaging lens 504 has a higher affinity. Therefore, distance data for the purpose of use can be acquired by making optical correction by the optical corrector 109 selectable according to the purpose of use of the distance data.

This embodiment uses the common optical system 113 for the light irradiated from the light emitter 101 onto the object and the light reflected by the object and received by the light receiver 102, but a similar effect can be obtained even if different optical systems are used for respective lights.

Next, in step 608, the CPU 104 causes the histogram generator 110 to generate a histogram of a predetermined class width binw for the distance data (distance L(r)) after optical correction or after emission correction when no optical correction is performed.

In a case where the generation of the histogram is completed, in step 609, the CPU 104 increments the histogram counter by 1.

Next, in step 610, the CPU 104 determines whether the histogram counter has reached a predetermined value (number of times) Hmax. In a case where it has reached that value, the generation of the histogram is complete and the flow proceeds to step 611. In a case where it has not reached the predetermined value Hmax, the flow returns to step 603 and repeats the acquisition of distance data.

In step 611, the CPU 104 causes the histogram generator 110 to perform histogram processing on the histogram. More specifically, the histogram is searched for a peak class with a frequency higher than that of the surrounding class, and the distance corresponding to the class with the highest frequency among at least one peak class is determined as the object distance.

FIG. 9 is a schematic diagram illustrating a histogram of distance data acquired at a specific pixel in the light receiving element array 301. FIG. 9 illustrates a state in which Hmax (pieces of) distance data divided into 16 classes with a class width binw have been acquired. The distance data acquired by the distance measuring apparatus may be affected by ambient light such as environmental light in addition to the light emitted from the light emitter 101. Thus, statistical processing is performed in the histogram generator 110 to identify the most likely distance data. In the histogram illustrated in FIG. 9, class 8, indicated by 901, has the highest frequency, so the distance data of class 8 is adopted as the distance to the object. The CPU 104 calculates distance data Lh as an average value using the following equation (17):

$$Lh = L ( i ) / num ( i ) \qquad ( 17 )$$

where L(i) is a distance data group belonging to class I, and num(i) is a frequency.

The distance data output from the histogram generator 110 is Lh(m,n) where m is a column number of the light receiving element in the light receiving element array 301, and n is a line number.

Next, in step 612, the CPU 104 increments the line counter by 1, since processing for one line has been completed.

Next, in step 613, the CPU 104 determines whether the line counter has reached a predetermined number of lines N. In a case where the predetermined number of lines N has been reached, acquisition of distance data for all lines has been completed and this flow ends. In a case where the predetermined number of lines N has not yet been reached, the flow returns to step 602 to acquire distance data for the next line.

This embodiment converts the delay amount between different devices (light emitter 101 and light receiver 102) and the delay amount within each device, which may be a cause of error in the acquired distance data, into distance data, and corrects the distance data using this. Thereby, distance data can be acquired with higher accuracy. This embodiment performs correction for the distance data output from the light receiver. Therefore, even if there are many points where delays occur because a light emitting element array and a light receiving element array are used, there is no need to incorporate circuits for correcting delays into the light emitter or light receiver, and the configuration of the light emitter and light receiver can be kept from becoming complicated.

As long as the positional relationship between the light emitting elements of the light emitter 101 and the pixels (light receiving elements) of the light receiver 102 is a conjugate relationship, the configuration may be such that light is emitted column by column and light is received column by column. In a case where delays occur in both the line (row) and column directions in each of the light emitter 101 and the light receiver 102, correction data may be provided for each direction. Thereby, highly accurate distance data can be acquired even if there is a difference in the delay amount in the line and column directions.

### Second Embodiment

A second embodiment will be described below. The second embodiment corrects an error in the distance data due to a time delay after a histogram of the distance data is obtained.

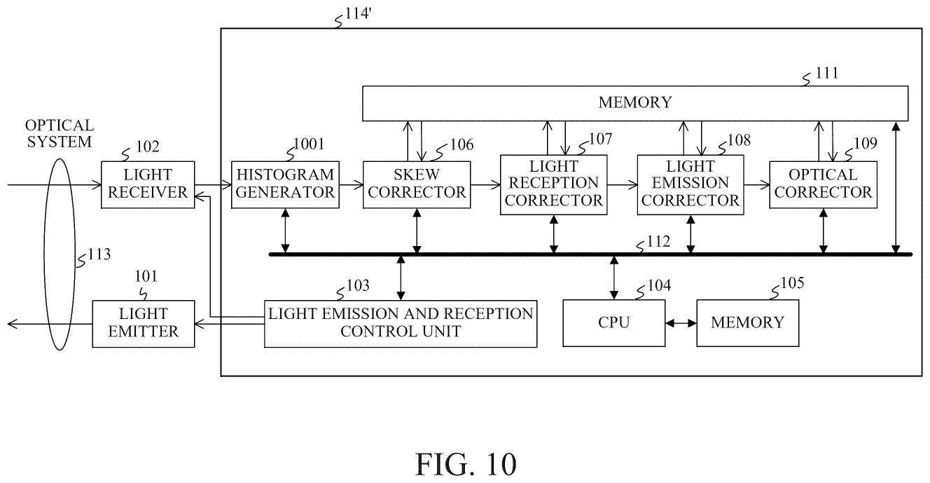

FIG. 10 illustrates the configuration of a distance measuring apparatus according to the second embodiment. Those elements in this embodiment, which are corresponding elements of the distance measuring apparatus illustrated in the first embodiment (FIG. 1), will be designated by the same reference numerals as in FIG. 1, and a description thereof will be omitted. In this embodiment, the signal processing circuit 114′ has a histogram generator 1001 configured to generate a histogram for the distance data before it is input to a skew corrector 106.

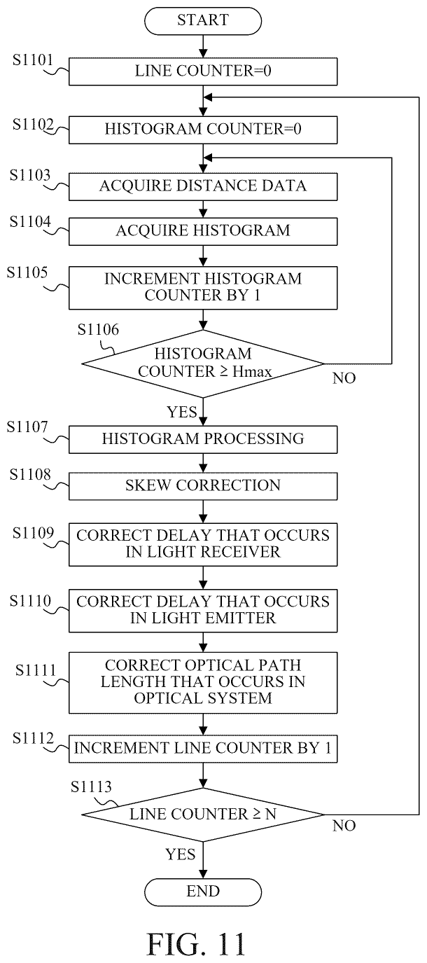

A flowchart in FIG. 11 illustrates processing to be executed by the CPU 104 in this embodiment. The processing of steps 1101 to 1103 is the same as the processing of steps 601 to 603 in the first embodiment (FIG. 6).

Next, in step 1104, the CPU 104 causes the histogram generator 1001 to generate a histogram with a predetermined class width binw for distance data (DTOF) obtained in step 1103. The histogram is as discussed in step 608 in FIG. 6.

In a case where the generation of the histogram is completed, in step 1105, the CPU 104 increments the histogram counter by 1.

Next, in step 1106, the CPU 104 determines whether the histogram has reached a predetermined value Hmax. In a case where the histogram has reached the predetermined value Hmax, the generation of the histogram is complete and the flow proceeds to step 1107. In a case where the histogram has not reached the predetermined value Hmax, the flow returns to step 1103 and the acquisition of distance data is repeated.

In step 1107, the CPU 104 causes the histogram generator 1001 to perform histogram processing for the histogram, similarly to step 611 in FIG. 6. Here, the CPU 104 calculates distance data DTOFh as an average value using the following equation (18):

$$DTOFh = DTOF ( i ) / num ( i ) \qquad ( 18 )$$

where DTOF(i) is a distance data group belonging to class i, and num(i) is a frequency.

The distance data output from the histogram generator 1001 is expressed as DTOFh(m,n), where m is the column number, and n is the line number of the light receiving element in the light receiving element array 301.

Next, in step 1108, the CPU 104 causes the skew corrector 106 to perform skew correction for the distance data DTOFh(m,n) obtained in step 1107. The distance data DTOFh(m,n) obtained from the histogram in step 1107 contains distance data corresponding to the time of flight of light and distance data as an error component caused by time delay. Thus, the distance data is corrected using the delay amounts (delay times) Tvd and Tsd. As in step 604 in FIG. 6, the delay amounts Tvd and Tsd are converted into distance data Dvd and Dsd using equations (5) and (6), and DTOFh(m,n) is corrected using the following equation (19):

$${DTOFh}^{′} ( m , n ) = DTOFh ( m , n ) + ( Dsd - Dvd ) \qquad ( 19 )$$

Next, in step 1109, the CPU 104 causes the light reception corrector 107 to perform light reception correction for the skew-corrected distance data DTOFh′(m,n) to correct the delay that occurs in the light receiver 102. The skew-corrected distance data DTOFh′(m,n) includes distance data corresponding to the time of flight of light and distance data corresponding to the delay that occurs in the light receiver 102. Thus, similarly to step 605 in FIG. 6, the delay amount Ts(n) is converted into distance data Ds(n) using equation (8), and DTOFh′(m,n) is corrected using the following equation (20):

$${DTOFh}^{″} ( m , n ) = {DTOFh}^{′} ( m , n ) - Ds ( n ) \qquad ( 20 )$$

Next, in step 1110, the CPU 104 causes the light emission corrector 108 to perform light emission correction for the distance data DTOFh″(m,n) after light reception correction, in order to correct the delay occurring in the light emitter 101. The distance data DTOFh″(m,n) after light reception correction contains distance data corresponding to the time of flight of light and distance data corresponding to the delay generated by the light emitter 101. Therefore, similarly to step 606 in FIG. 6, the delay amount Tv(m) is converted into distance data using equation (11), and DTOFh″(m,n) is corrected using the following equation (21):

$${DTOFh}^{′′′} ( m , n ) = {DTOFh}^{″} ( m , n ) - Dv ( m ) \qquad ( 21 )$$

Next, in step 1111, the CPU 104 causes the optical corrector 109 to perform optical correction for the distance data DTOFh′″(m,n) after light emission correction to correct the optical path length difference generated in the optical system 113. Here, as in step 607 in FIG. 6, the correction illustrated in equation (16) is performed in a case where the distance data is used for focusing in acquiring an image signal of a two-dimensional plane captured by the camera using the imaging optical system, etc.

The processing in the next steps 612 and 613 is the same as that in FIG. 6.

This embodiment performs the histogram processing for the distance data acquired by the light receiver 102, then converts a delay amount between devices and a delay amount within a device, which may be a cause of error in the distance data, into distance data, and corrects the distance data using it. Thereby, highly accurate distance data can be obtained with a small calculation amount.

### Third Embodiment

Next, a third embodiment will be described. The third embodiment corrects distance data errors due to time delays in distance data corresponding to the temperatures of the light emitter 101 and the light receiver 102.

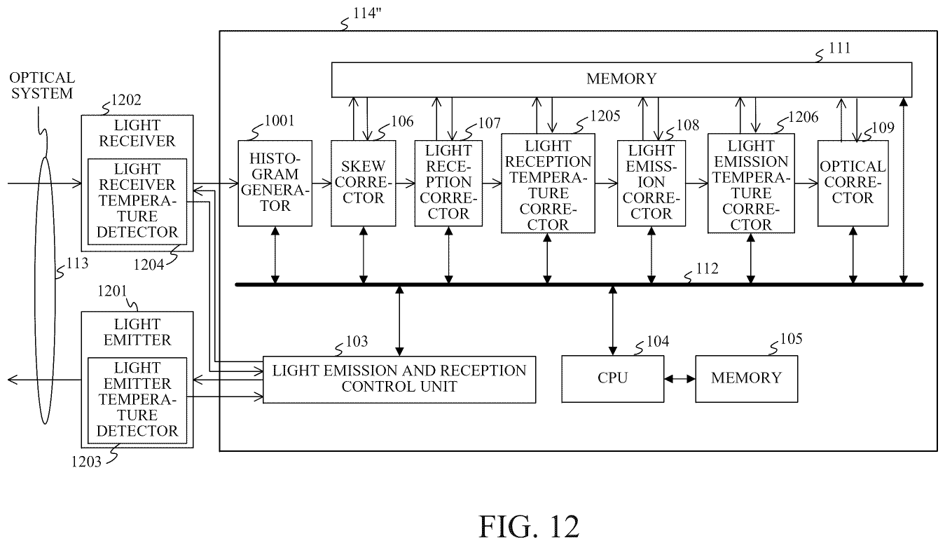

FIG. 12 illustrates the configuration of a distance measuring apparatus according to the third embodiment. Those elements in this embodiment, which are corresponding elements in the distance measuring apparatus illustrated in the first embodiment (FIG. 1), will be designated by the same reference numerals as in FIG. 1, and a description thereof will be omitted. In this embodiment, each of the light emitter 1201 corresponding to the light emitter 101 in the first and second embodiments and the light receiver 1202 includes a light-emitter temperature detector 1203 and a light-receiver temperature detector 1204 as temperature acquiring units.

Since the light emitting element array 201 is constantly repeating light emission, the temperature inside the light emitter 1201 is likely to rise. The rise in temperature inside the light emitter 1201 can be a factor that causes a decrease in the light emitting efficiency of the light emitting element and a deterioration in the electrical characteristics of wiring, transistors, etc. In a case where the delay amount inside the light emitter 1201 changes due to these factors, an error occurs in the obtained distance data, so the temperature of the light emitting element array 201 is obtained by the light-emitter temperature detector 1203, and the temperature information is sent to the light emission and reception control unit 103.

In the light receiver 1202, a current due to avalanche breakdown is constantly generated in the light receiving element array 301, and the temperature inside the light receiver 1202 is likely to rise. The rise in temperature inside the light receiver 1202 can cause a decrease in the light receiving efficiency of the pixels (light receiving elements) and deterioration of the electrical characteristics of the wiring and transistors, etc. In a case where the delay amount inside the light receiver 1202 changes due to these factors, an error will occur in the obtained distance data. Therefore, the temperature of the light receiving element array 301 is obtained by the light-receiver temperature detector 1204, and the temperature information is sent to the light emission and reception control unit 103.

A signal processing circuit 114″ according to this embodiment includes the histogram generator 1001 and correctors 106 to 109, similarly to the signal processing circuit 114′ according to the second embodiment. Moreover, the signal processing circuit 114″ includes a light reception temperature corrector 1205 after the light reception corrector 107, and an emission temperature corrector 1206 after the emission corrector 108.

The light reception temperature corrector 1205, which serves as a fifth corrector, corrects errors in the distance data caused by the delay amount (fifth delay time) in the light receiver 1202 that varies depending on the temperature. More specifically, the light reception temperature corrector 1205 corrects the distance data after the light receiving correction in the light reception corrector 107 using a light receiving temperature correction value according to a change amount in the temperature of the light receiver 1202 (fifth correction).

The light emission temperature corrector 1206 corrects errors in the distance data caused by the delay amount in the light receiver 1202 that varies depending on the temperature. More specifically, the emission temperature corrector 1206 corrects distance data after the light emission correction by the light emission corrector 108 using an emission temperature correction value according to the change amount in temperature of the emitter 1201.

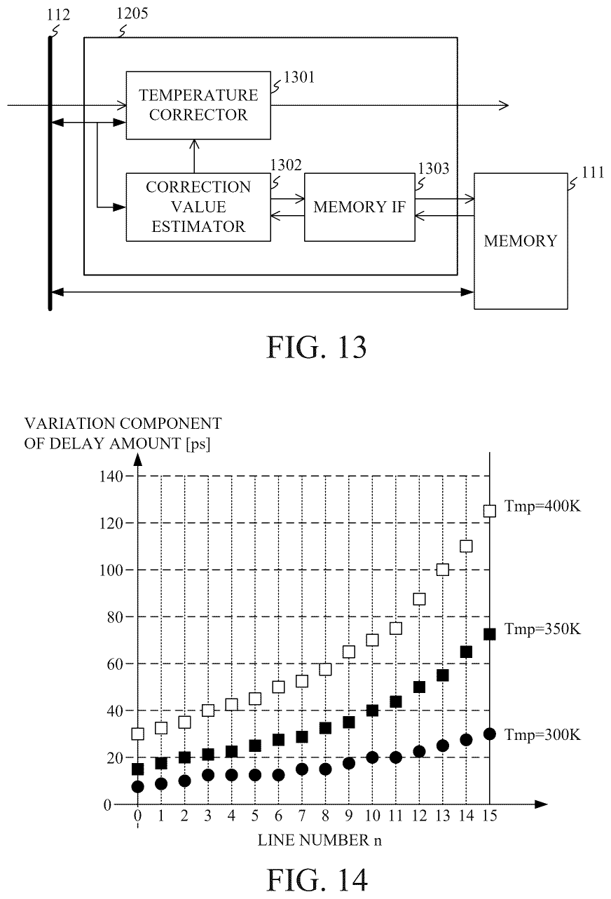

FIG. 13 illustrates the configuration of the light reception temperature corrector 1205. The light reception temperature corrector 1205 includes a temperature corrector 1301, a correction value estimator 1302, and a memory interface 1303. The light reception temperature correction values can be stored for all temperatures in the memory 111. Since the data amount for the light reception temperature correction values would be enormous, this embodiment estimates (obtains) the light reception temperature correction value for each temperature using a function that is an approximation equation. The correction value estimator 1302 obtains the coefficients for the approximation function that are stored in advance in the memory 111 via the memory interface 1303.

FIG. 14 illustrates an example of the variation component of the delay amount due to temperature change, plotted for each line number of the light receiving element array 301. In FIG. 14, the temperature 250K is set as a reference temperature, and the variation component of the delay amount measured in advance at 50K intervals from the reference temperature is illustrated in picoseconds (ps). The delay amount at 250K as the reference temperature is corrected by the light reception corrector 107, and the delay amount at a temperature different from 250K is corrected by the light reception temperature corrector 1205. The variation component (variation amount) of the delay amount for each temperature is approximated by a quadratic polynomial approximation function (first function). The following equation (22) illustrates an approximation function at 300K, equation (23) illustrates an approximation function at 350K, and equation (24) illustrates an approximation function at 400K, respectively:

$$P ( n ) \_ 300 K = f\_ 300 K \times {n}^{2} + g\_ 300 K \times n + h\_ 300 K \qquad ( 22 )$$

$$P ( n ) \_ 350 K = f\_ 350 K \times {n}^{2} + g\_ 350 K \times n + h\_ 350 K \qquad ( 23 )$$

$$P ( n ) \_ 400 K = f\_ 400 K \times {n}^{2} + g\_ 400 K \times n + h\_ 400 K \qquad ( 24 )$$

In equations (22) to (24), f_300K, g_300K, h_300K, f_350K, g_350K, h_350K, f_400K, g_400K, and h_400K are coefficients of the approximation functions at each temperature. The correction value estimator 1302 selects an approximation function to be used based on the temperature information obtained from the light-receiver temperature detector 1204, reads the coefficients of the approximation function from the memory 111, and estimates the light reception temperature correction value. In a case where the delay amount due to the temperature change is corrected at a temperature other than the above temperatures, the approximation function illustrated in the following equation (25) is used:

$$P ( n ) \_t = f ( t ) \times {n}^{2} + g ( t ) \times n + h ( t ) \qquad ( 25 )$$

where t is temperature, and P(n)_t is a fluctuation component of the delay amount of the n-th line at temperature t.

f(t) is a function indicating a quadratic coefficient at temperature t, g(t) is a function indicating a linear coefficient at temperature t, and h(t) is a function indicating the zeroth coefficient at temperature t, and are approximated by quadratic functions (second functions) as illustrated in the following equations (26) to (28):

$$f ( t ) = a \times {t}^{2} + b \times t + c \qquad ( 26 )$$

$$g ( t ) = a \times {t}^{2} + b \times t + c \qquad ( 27 )$$

$$h ( t ) = a \times {t}^{2} + b \times t + c \qquad ( 28 )$$

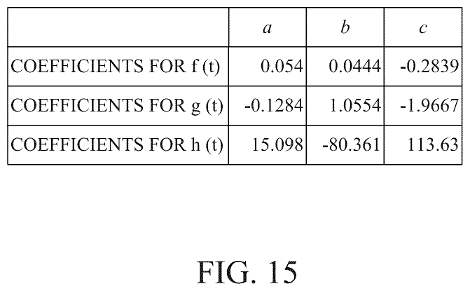

The combinations of coefficients a, b, and c in equations (26) to (28) are calculated in advance, and the calculation results are written into the memory 105. The CPU 104 reads coefficients a, b, and c from the memory 105 and stores them as table data in the memory 111 via the bus 112. FIG. 15 illustrates an example of the coefficients a, b, and c in an approximation function of the coefficients in equations (26) to (28).

By approximating the coefficients of the approximation function with a multidimensional function in this way and storing the approximated coefficients in the memory 111 in advance, it becomes unnecessary to store the light receiving temperature correction values for the number of lines of the light receiving element array 301 in the memory 111 for all temperatures.

The correction value estimator 1302 references the data on the coefficients a, b, and c of the approximation function stored in the memory 111, and obtains the temperature t obtained by the light-receiver temperature detector 1204 from the light emission and reception control unit 103. Then, using the approximation functions of equations (26) to (28), it calculates the coefficients f(t), g(t), and h(t) at temperature t. Next, the correction value estimator 1302 calculates the fluctuation component P(n)_t of the delay amount in the n-th line using the calculated coefficients f(t), g(t), and h(t) and equation (25), and sends the data of this fluctuation component to the temperature corrector 1301.

The temperature corrector 1301 converts the fluctuation component P(n)_t of the input delay amount into distance data P′(n)_t using the light speed c. Then, using the converted P′(n)_t, the distance data DTOFh″(m,n) after light reception correction in the light reception corrector 107 is corrected as illustrated in the following equation (29):

$${DTOFh}^{″} ( m , n ) = {DTOFh}^{″} ( m , n ) - {P}^{′} ( n ) \_t \qquad ( 29 )$$

The light emission temperature corrector 1206 has a configuration similar to the light reception temperature corrector 1205. The light emission temperature corrector 1206 estimates a light emission temperature correction value as correction data using temperature information obtained by the light-emitter temperature detector 1203 as a temperature acquiring unit and data on the coefficients for the approximate function stored in advance in the memory 111. Then, distance data DTOFh′″(m,n) after light emission correction in the light emission corrector 108 is corrected using an equation similar to equation (29). Thereby, the distance data for the delay amount in the light emitter 1201 can be corrected, which changes depending on the temperature.

This embodiment estimates the delay change due to the temperature change using information on the temperature changes of the light emitter 101 and the light receiver 102 and coefficients for the approximation function calculated in advance and stored in the memory 111, and corrects the distance data. Thereby, highly accurate distance data can be acquired with a small calculation amount.

In this embodiment, the distance data is corrected according to the temperature in both the light emitter 1201 and the light receiver 1202, but the distance data may be corrected according to the temperature in at least one of the light emitter 1201 and the light receiver 1202.

In the above embodiments, skew correction, light reception correction, light emission correction, optical correction, and temperature correction are performed for the distance data, but at least one of these corrections may be performed.

The distance measuring apparatus according to each of the above embodiments can be included in a processing apparatus that performs processing using distance data obtained from the distance measuring apparatus, which is mounted on an image pickup apparatus such as a camera, an electronic apparatus such as a smartphone, a movable apparatus such as an automobile, and a variety of other apparatuses. For example, in an image pickup apparatus or an electronic apparatus, the processing apparatus can perform focus control (AF) using distance data as described above and generate a distance map within an angle of view. In a movable apparatus, the processing apparatus can form part of an Electronic Control Unit (ECU) that measures the distance to the vehicle ahead, detects any obstacle, controls the brakes and steering wheel, and issues alerts.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Each embodiment according to this disclosure can accurately measure an object distance using a TOF distance measuring method.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. A distance measuring apparatus comprising:
a light emitter configured to emit light to be irradiated onto an object and including a light emitting element, and a drive unit configured to output a drive voltage for causing the light emitting element to emit the light;
a light receiver configured to detect light reflected by the object among the light from the light emitter, measure a time of flight of the light from the light emitter, and generate distance data based on the time of flight;
one or more memories storing instructions; and
one or more processors that, upon execution of the instructions, operate to correct the distance data based on a first delay time from when the light emitter is instructed to emit the light to when the light emitter emits the light, a second delay time from when the light emitter is instructed to emit the light to when the light receiver starts measuring the time of flight, and a third delay time from when the drive unit outputs the drive voltage to when the light emitting element emits the light,
wherein the light emitter includes a plurality of light emitting elements, and
wherein the one or more processors operate to perform correction based on the third delay time for each light emitting element.

2. The distance measuring apparatus according to claim 1, wherein the one or more processors performs the correction using data obtained by converting the first delay time and the second delay time into distances.

3. The distance measuring apparatus according to claim 1, wherein the light receiver includes a counter configured to count at a predetermined cycle, and
wherein the distance data is generated based on a count value of the time of flight counted by the counter.

4. The distance measuring apparatus according to claim 3, wherein the one or more processors operate to perform the correction using count values converted from the first delay time and the second delay time.

5. The distance measuring apparatus according to claim 1, wherein the one or more processors operate to perform the correction based on the first delay time after performing the correction based on the second delay time.

6. The distance measuring apparatus according to claim 1, wherein the light receiver includes a light receiving element and a measuring unit configured to detect a signal output from the light receiving element and measure the time of flight, and
wherein the one or more processors operate to perform the correction based on a fourth delay time from when the signal is output from the light receiving element to when the signal output from the light receiving element reaches the measuring unit.

7. The distance measuring apparatus according to claim 6, wherein the light receiver includes a plurality of light receiving elements, and
wherein the one or more processors operate to perform the correction based on the fourth delay time for each of the light receiving elements.

8. The distance measuring apparatus according to claim 1, further comprising an imaging optical system through which the light emitted from the light emitter and the light reflected by the object pass,
wherein the one or more processors operate to perform the correction according to an image height in the light receiver and a focal length of the imaging optical system.

9. The distance measuring apparatus according to claim 1, further comprising a temperature acquiring unit configured to acquire a temperature of at least one of the light emitter and the light receiver,
wherein the one or more processors operate to perform the correction based on a fifth delay time according to the temperature in the at least one.

10. The distance measuring apparatus according to claim 9, wherein the light receiver includes a plurality of light receiving elements, and
wherein the one or more processors operate to perform the correction based on the fifth delay time for each of the light emitting elements or for each of the light emitting elements.

11. The distance measuring apparatus according to claim 9, wherein the one or more processors operate to:
estimate a correction value corresponding to the fifth delay time using an approximation function, and
perform the correction using the estimated correction value.

12. The distance measuring apparatus according to claim 1, wherein the one or more processors operate to:
generate a histogram of a plurality of distance data after correction by the one or more processors, and
output distance data determined based on the histogram.

13. The distance measuring apparatus according to claim 1, wherein the one or more processors operate to:
generate a histogram of a plurality of distance data generated by the light receiver and outputting distance data determined based on the histogram, and
correct the distance data determined based on the histogram.

14. A distance measuring apparatus comprising:
a light emitter configured to emit light to be irradiated onto an object;
a light receiver configured to detect light reflected by the object among the light from the light emitter, measure a time of flight of the light from the light emitter, and generate distance data based on the time of flight;
one or more memories storing instructions; and
one or more processors that, upon execution of the instructions, operate to:
correct the distance data based on a first delay time from when the light emitter is instructed to emit the light to when the light emitter emits light, and a second delay time from when the light emitter is instructed to emit the light to when the light receiver starts measuring the time of flight,
correct the distance data based on a third delay time from when a drive unit in the light receiver outputs a drive voltage for causing the light emitting element to emit the light to when the light emitting element emits the light,
correct the distance data based on a fourth delay time from when the signal is output from the light receiving element to when the signal output from the light receiving element reaches the measuring unit,
correct the distance data according to an image height in the light receiver and a focal length of an imaging optical system through which the light emitted from the light emitter and the light reflected by the object pass, and
correct the distance data based on a fifth delay time according to a temperature in at least one of the light emitter and the light receiver.

15. A processing apparatus comprising:
the distance measuring apparatus according to claim 1,
wherein the processing apparatus performs processing using the distance data from the distance measuring apparatus.

16. A processing apparatus comprising:
the distance measuring apparatus according to claim 14,
wherein the processing apparatus performs processing using the distance data from the distance measuring apparatus.

17. A distance measuring method using a light emitter configured to emit light to be irradiated onto an object and including a light emitting element, and a drive unit configured to output a drive voltage for causing the light emitting element to emit the light, a light receiver configured to detect light reflected by the object among the light from the light emitter, measure a time of flight of the light from the light emitter, and generate distance data based on the time of flight, the distance measuring method comprising:
correcting the distance data based on a first delay time from when the light emitter is instructed to emit the light to when the light emitter emits the light, a second delay time from when the light emitter is instructed to emit the light to when the light receiver starts measuring the time of flight, and a third delay time from when the drive unit outputs the drive voltage to when the light emitting element emits the light,
wherein the light emitter includes a plurality of light emitting elements, and
wherein correcting is based on the third delay time for each light emitting element.

18. A distance measuring method configured to correct distance data using a light emitter configured to emit light to be irradiated onto an object, and a light receiver configured to detect light reflected by the object among the light from the light emitter, measure a time of flight of the light from the light emitter, and generate distance data based on the time of flight, the distance measuring method comprising:
correcting the distance data based on a first delay time from when the light emitter is instructed to emit the light to when the light emitter emits light, and a second delay time from when the light emitter is instructed to emit the light to when the light receiver starts measuring the time of flight,
correcting the distance data based on a third delay time from when a drive unit in the light receiver outputs a drive voltage for causing the light emitting element to emit the light to when the light emitting element emits the light,
correcting the distance data based on a fourth delay time from when the signal is output from the light receiving element to when the signal output from the light receiving element reaches the measuring unit,
correcting the distance data according to an image height in the light receiver and a focal length of an imaging optical system through which the light emitted from the light emitter and the light reflected by the object pass, and
correcting the distance data based on a fifth delay time according to a temperature in at least one of the light emitter and the light receiver.

19. A computer-readable storage medium storing a program that causes a computer to execute the distance measuring method according to claim 17.

20. A computer-readable storage medium storing a program that causes a computer to execute the distance measuring method according to claim 18.
